(19) United States
(12) Patent Application Publication
(10) Pub. No.: US 2010/0074127 A1
(43) Pub. Date: Mar. 25, 2010

(54) CHANNEL MEASUREMENTS ON COMBINED PILOT SIGNALA IN MULTI-CARRIER SYSTEMS

(76) Inventors: Lei Xiao, Beijing (CN); Jiuhui Du, Solna (SE)

Correspondence Address: ERICSSON INC., 6300 LEGACY DRIVE, M/S EVR 1-C-11, PLANO, TX, 75024, US

(21) Appl. No.: 12/527,525

(22) PCT Filed: Feb. 15, 2007
(86) PCT No.: PCT/SE2007/050089

§ 371 Date: Aug. 17, 2009

(51) Int. Cl. H04L 12/26

(52) U.S. Cl. 370/252; 370/241

(57) ABSTRACT

In a base station and a mobile station the pilot signal power in all carriers are combined for example by using an MRC (Maximum Ratio Combination) algorithm. Physical layer measurement such as Up-Link Synchronization and Angle of Arrival (AoA) are performed based on the combined received signal. The method results in that the measurement errors can be significantly reduced.

### TECHNICAL FIELD

The present invention relates to a method and a device for carrying out measurements in a cellular radio systems having multiple carriers.

### BACKGROUND

Time Division-Synchronous Code Division Multiple Access TD-SCDMA uses Time division duplex TDD, in contrast to the frequency division duplex FDD scheme used by Wideband Code Division Multiple Access WCDMA systems. By dynamically adjusting the number of timeslots used for downlink and uplink, the system can more easily accommodate asymmetric traffic with different data rate requirements on downlink and uplink than FDD schemes. Since it does not require paired spectrum for downlink and uplink, spectrum allocation flexibility is also increased. Also, using the same carrier frequency for uplink and downlink means that the channel condition is the same on both directions, and the base station can deduce the downlink channel information from uplink channel estimates, which is helpful to the application of beamforming techniques.

TD-SCDMA also uses TDMA in addition to the CDMA used in WCDMA. This reduces the number of users in each timeslot, which reduces the implementation complexity of multi-user detection and beamforming schemes, but the non-continuous transmission also reduces coverage (because of the higher peak power needed), mobility (because of lower power control frequency) and complicates radio resource management algorithms. The “S” in TD-SCDMA stands for “synchronous”, which means that uplink signals are synchronized at the base station receiver, achieved by continuous timing adjustments. This reduces the interference between users of the same timeslot using different codes by improving the orthogonality between the codes, therefore increasing system capacity, at the cost of some hardware complexity in achieving uplink synchronization.

In TD systems, midamble code is a training sequence, similar to the pilot channel in WCDMA. Midamble code is typically located between two segments of data. For both the base station, NodeB, and the mobile station or User Equipment, UE, midamble code is used in the first step of baseband processing and channel estimation. From the channel estimation NodeB and UE can get CIR (Channel Impulse Response). Based on this, the NodeB can measure the arrival time for Uplink synchronization, AoA (Angel of Arrival) for beamforming generation and the Receiving power of receiving signal. Similarly the UE can measure the arrival time for downlink synchronization, the receiving power of receiving signal and so on. Moreover the Channel Impulse Response can also be used for coherent demodulation for receiving data.

Moreover, multi carrier methods are used in both TD-SCDMA and TD-HSDPA High-Speed Downlink Packet Access and also in HSUPA High-Speed Uplink Packet Access systems. In a multi carrier TD-HSDPA, it is possible that one single User Equipment UE is allocated resources in a multiple of carriers, e.g. two, three or even more carriers.

The multi-carrier concept has recently been introduced in HSDPA and still not yet in HSUPA for TD-SCDMA. However, Midamble code measurements are isolated for each carrier as in a single carrier system. In a multi-carrier system this can introduce a bigger measurement error, which is undesired.

Hence, there exist a need for a method and a system that is able to eliminate or at least reduce measurement errors in N-carrier TD-SCDMA systems using Midamble codes and other multi-carrier systems like orthogonal frequency division multi-access OFDM systems using pilot codes/signals.

### SUMMARY

It is an object of the present invention to overcome or at least reduce some of the problems associated with existing measurements of pilot signals in multi-carrier systems.

This object and others are obtained by the method, the base station and the mobile station as set out in the appended claims. Thus, by combining the power in all carriers of a multi-carrier system, for example by using an MRC (Maximum Ratio Combination) algorithm, and perform the physical layer measurement such as Up-Link Synchronization and Angle of Arrival (AoA) based on the combined received signal, the measurement errors can be significantly reduced. IN particular, if the multi-carrier system is a system employing midamble codes such as TD-SCDMA, the power of the midamble codes are combined.

Hence, in the case that resource units in multiple carriers are allocated to one user, the UE, in case of a down link signal, or NodeB, in case of an up-link signal, receiving signals on the air interface, will jointly detect all midamble signals at all carriers with radio resources allocated to this user using a suitable combination algorithm such as an MRC algorithm into a combined signal.

Based on this combination result, i.e. the combined signal, normal measurement like timing, Angle of Arrival (AoA), receiving power, CIR and so on are performed.

As a result of the diversity gain of such an approach, the measurement will be much more accurate than a measurement carried out in only one carrier. Because down-link synchronization and, Angle of Arrival (AoA) measurement are critical to the performance of a system like the TD-SCDMA system, this will significantly improve the signal receiving quality of such a system.

### BRIEF DESCRIPTION OF THE DRAWINGS

The present invention will now be described in more detail by way of non-limiting examples and with reference to the accompanying drawings, in which:

FIG. 1 is a view of a cellular radio system employing multiple carriers.

FIG. 2 is a flow chart illustrating different steps performed when performed when carrying out measurements for a UE.

### DETAILED DESCRIPTION

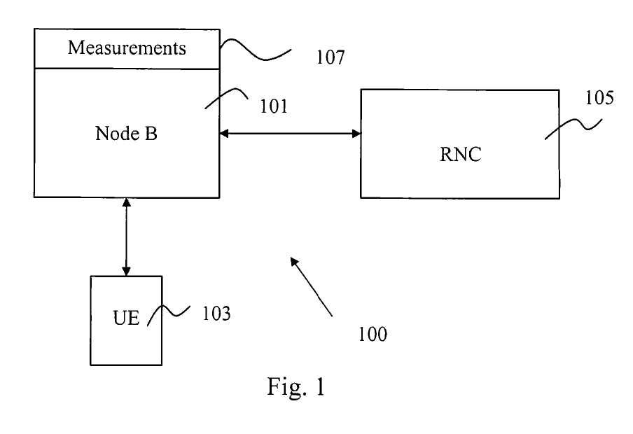

In FIG. 1 a view of a TD-SCDMA system using midamble codes to implement channel measurement at the physical layer is shown. The TD-SCDMA system is given as an example of a multi-carrier system, the invention is however not limited to TD-SCDMA systems but can be applied to any multi-carrier cellular radio system. The system 100 comprises a base station (Node B) 101. The base station 101 serves a number of mobile terminals, usually termed User Equipment (UE) 103, located within the area covered by the base station 101. The base station 101 is also connected to a radio network controller node (RNC) 105. The system 100 also comprises a control and measurement unit 107 for carrying out different measurements relating to the UEs of the cell served by the base station 101. The unit 107 is preferably co-located or an integral part of the base station 101.

Furthermore, the UE 103 also comprises hardware and software to process signals received from the base station 101 in order to carry out measurements on the channel between the base station and the UE.

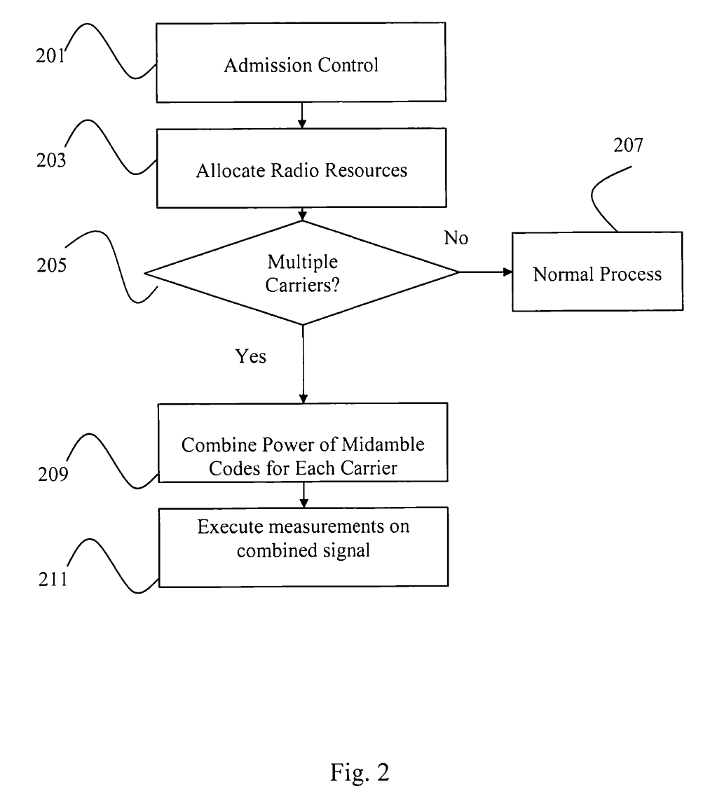

In FIG. 2 a flow chart illustrating steps performed when carrying out measurements in a NodeB for a UE in a cellular radio system such as the system depicted in FIG. 1. First in a step 201, the NodeB decides whether or not to admit a new UE in a conventional manner using known procedures for admission control. Once the NodeB has accepted the UE radio resources are allocated to the UE in a step 203.

The radio resources allocated in step 203 may be distributed to more than one carrier. In step 205 the procedure detects the number of carriers assigned to the UE. If the radio resources are confined to one carrier, the procedure proceeds to a step 207 where normal measurements are carried out. If on the other hand the radio resources are distributed on multiple carriers, the procedure proceeds to a step 209. In step 209 the power of the midamble codes arc combined for all carriers for example by using an MRC (Maximum Ratio Combination) algorithm. Thereupon in a step 211, the normal measurements are performed using the combined signal as input.

Hence, in the case that resource units in many carriers are allocated to one user, the UE, in case of a down link signal, or NodeB, in case of an up-link signal, receiving signals on the air interface, will jointly detect all midamble signals at all carriers with radio resources allocated to this user using a suitable combination algorithm such as an MRC algorithm into a combined signal.

Based on this combination result, i.e. the combined signal, normal measurement like timing, Angle of Arrival (AoA), receiving power power, CIR and so on are performed.

As a result of the diversity gain of the method and device as described herein, the measurement will be much more accurate than a measurement carried out in only one carrier. Because down-link synchronization and, Angle of Arrival (AoA) measurement are critical to the performance of a system like the TD-SCDMA system, the method and device as described herein will significantly improve the signal receiving quality of such a system.

1. A method of performing channel measurements in a multi-carrier cellular radio system, comprising the steps of:
receiving a data signal on multiple carriers, a pilot signal being received on each carrier;
combining the power of the multiple pilot signals into a combined pilot signal and,
performing channel measurements of the combined pilot signal.

2. The method according to claim 1, wherein the power of the pilot signals are combined using a Maximum Ratio Combination (MRC) algorithm.

3. The method according to claim 1, wherein the performed channel measurements include measurement of the Channel Impulse Response (CIR).

4. The method according to claim 1, wherein performed channel measurements include measurement of receiving power.

5. The method according to claim 1, wherein performed channel measurements include measurement of up-link synchronization

6. The method according to claim 1, wherein performed channel measurements include measurement of the Angle of Arrival (AoA).

7. The method according to claim 1, wherein the pilot signal is a midamble code.

8. A base station, comprising:
means for receiving a data signal on multiple carriers, a pilot signal being received on each carrier;
means for combining the power of the pilot signals into a combined pilot signal; and,
means for performing channel measurements of the combined pilot signal.

9. The base station according to claim 8, further comprising means for combining the power of the pilot signals using a Maximum Ratio Combination (MRC) algorithm.

10. The base station according to claim 8, further comprising means for performing measurements of the Channel Impulse Response (CIR).

11. The base station according to claim 8, further comprising means for performing measurements of the receiving power.

12. The base station according to claim 8, further comprising means for performing measurements of the arrival time for performing up-link synchronization.

13. The base station according to claim 8, further comprising means for performing measurements of the Angle of Arrival (AoA).

14. The base station according to claim 8, wherein the pilot signal is a midamble code.

15. A mobile station, comprising:
means for receiving a data signal on multiple carriers, a pilot signal being received on each carrier;
means for combining the power of the pilot signals into a combined pilot signal and,
means for performing channel measurements of the combined pilot signal.

16. The mobile station according to claim 15, further comprising means for combining the power of the pilot signals using a Maximum Ratio Combination (MRC) algorithm.

17. The mobile station according to claim 15, further comprising means for performing measurements of the Channel Impulse Response (CIR).

18. The mobile station according to claim 15, further comprising means for performing measurements of the receiving power.

19. The mobile station according to claim 15, further comprising means for performing measurements of the arrival time for performing down-link synchronization.

20. The mobile station according to claim 15, wherein the pilot signal is a midamble code.
